(19) United States
(12) Patent Application Publication
(10) Pub. No.: US 2025/0373286 A1
(43) Pub. Date: Dec. 4, 2025

(54) TRANSMIT ANTENNA SELECTION THROUGHPUT PREDICTION

(71) Applicant: Samsung Electronics Co., Ltd., Suwon-si (KR)

(72) Inventors: Tiexing Wang, Melissa, TX (US); Nadisanka Rupasinghe, McKinney, TX (US); Yang Li, Plano, TX (US)

(21) Appl. No.: 19/051,071

(22) Filed: Feb. 11, 2025

Related U.S. Application Data
(60) Provisional application No. 63/655,976, filed on Jun. 4, 2024.

(51) Int. Cl. H04B 7/0413; H04B 7/06

(52) U.S. Cl. CPC H04B 7/0413; H04B 7/0608; H04B 7/0632

(57) ABSTRACT

An embodiment provides for calculating transmit antenna selection (TAS) throughput prediction for MIMO mode selection using a linear model that may use a piece-wise linear mapping from effective downlink (DL) signal to interference and noise ratio (SINR) in a decibel (dB) domain to spectral efficiency (SE) and the DL SINR may be estimated by uplink SINR, beamforming loss and a channel quality indicator value.

### CROSS-REFERENCE TO RELATED APPLICATION(S)

This application claims the benefit of priority from U.S. Provisional Application No. 63/655,976, entitled “TRANSMIT ANTENNA SELECTION (TAS) THROUGHPUT PREDICTION” filed Jun. 4, 2024, which is incorporated herein by reference in its entirety.

### TECHNICAL FIELD

This disclosure relates generally to a wireless communication system, and more particularly to, for example, but not limited to, transmit antenna selection (TAS) in wireless networks.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The description set forth in the background section should not be assumed to be prior art merely because it is set forth in the background section. The background section may describe aspects or embodiments of the present disclosure.

### SUMMARY

One aspect of the present disclosure provides a base station (BS) in a wireless network, comprising a memory and a processor coupled to the memory. The processor is configured to receive, from a user equipment (UE), a set of input metrics. The processor is configured to perform, from the set of input metrics, a mapping from a channel quality indicator (CQI) to signal to noise ratio (SNR). The processor is configured to perform a transmit antenna selection (TAS) throughput prediction using a linear model that uses the mapping from the CQI to SNR. The processor is configured to select a TAS mode as a multiple input multiple output (MIMO) mode based on the TAS throughput prediction.

In some embodiments, the set of input metrics is associated with at least one of a CQI, a rank indicator, a number of layers, a modulation and coding scheme, a beamforming loss, an uplink sounding reference signal (SRS) signal to noise ratio (SNR), a downlink SNR, or a hybrid automatic repeat request (HARQ) acknowledgement and negative acknowledgement.

In some embodiments, the TAS throughput predication is approximated by a linear function based on the mapping from CQI to SNR, a beamforming loss, and an SRS to generate a spectral efficiency.

In some embodiments, the linear function is bounded by a lower bound and an upper bound on the spectral efficiency per layer that is supported by the BS.

In some embodiments, the linear function is bounded by a lower bound and an upper bound on a total spectral efficiency that is supported by the BS.

In some embodiments, the processor is further configured to select a particular linear function from a plurality of linear functions based on at least one of a number of UEs, a network load, or a power consumption.

In some embodiments, the processor is further configured to select a particular linear function from a plurality of linear functions for a particular UE based on a traffic type or a quality of service (QoS) requirement.

In some embodiments, the mapping from CQI to SNR is variable based on a cell to which the BS belongs, a UE with which the BS communicates, or a configuration of the BS.

In some embodiments, the processor is further configured to offset the TAS throughput predication by a pre-defined parameter.

In some embodiments, the TAS throughput predication is performed based on a parameter that changes based on uplink SNR or based on UE speed.

One aspect of the present disclosure provides a computer-implemented method for communication by a base station (BS) in a wireless network. The method comprises receiving, from a user equipment (UE), a set of input metrics. The method comprises performing, from the set of input metrics, a mapping from a channel quality indicator (CQI) to signal to noise ratio (SNR). The method comprises performing a transmit antenna selection (TAS) throughput prediction using a linear model that uses the mapping from the CQI to SNR. The method comprises selecting a TAS mode as a multiple input multiple output (MIMO) mode based on the TAS throughput prediction.

In some embodiments, the set of input metrics is associated with at least one of a CQI, a rank indicator, a number of layers, a modulation and coding scheme, a beamforming loss, an uplink sounding reference signal (SRS) signal to noise ratio (SNR), a downlink SNR, or a hybrid automatic repeat request (HARQ) acknowledgement and negative acknowledgement.

In some embodiments, the TAS throughput predication is approximated by a linear function based on the mapping from CQI to SNR, a beamforming loss, and an SRS to generate a spectral efficiency.

In some embodiments, the linear function is bounded by a lower bound and an upper bound on the spectral efficiency per layer that is supported by the BS.

In some embodiments, the linear function is bounded by a lower bound and an upper bound on a total spectral efficiency that is supported by the BS.

In some embodiments, the method further comprises selecting a particular linear function from a plurality of linear functions based on at least one of a number of UEs, a network load, or a power consumption.

In some embodiments, the method further comprises selecting a particular linear function from a plurality of linear functions for a particular UE based on a traffic type or a quality of service (QoS) requirement.

In some embodiments, the mapping from CQI to SNR is variable based on a cell to which the BS belongs, a UE with which the BS communicates, or a configuration of the BS.

In some embodiments, the method further comprises offsetting the TAS throughput predication by a pre-defined parameter.

In some embodiments, the TAS throughput predication is performed based on a parameter that changes based on uplink SNR or based on UE speed.

### BRIEF DESCRIPTION OF THE DRAWINGS

FIG. 1 shows an example of a wireless network in accordance with an embodiment.

FIGS. 2A and 2B illustrate example wireless transmit and receive paths in accordance with an embodiment.

FIG. 3A illustrates an example user equipment (UE) in accordance with an embodiment.

FIG. 3B illustrates an example gNodeB (gNB) in accordance with an embodiment.

FIG. 4 illustrates a beamforming architecture in accordance with an embodiment.

FIG. 5 illustrates an example block diagram for an AI-augmented multiple-input multiple-output (MIMO) mode adaptation method in accordance with an embodiment.

FIG. 6 illustrates an example block diagram for a TAS throughput prediction method in accordance with an embodiment.

FIG. 7 illustrates an example of antenna switching in accordance with an embodiment.

FIG. 8 illustrates a channel quality indicator (CQI) to signal to interference and noise ratio (SINR) mapping table in accordance with an embodiment.

FIG. 9 illustrates a flow chart of an example process of computing TAS throughput using a linear model in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11 be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

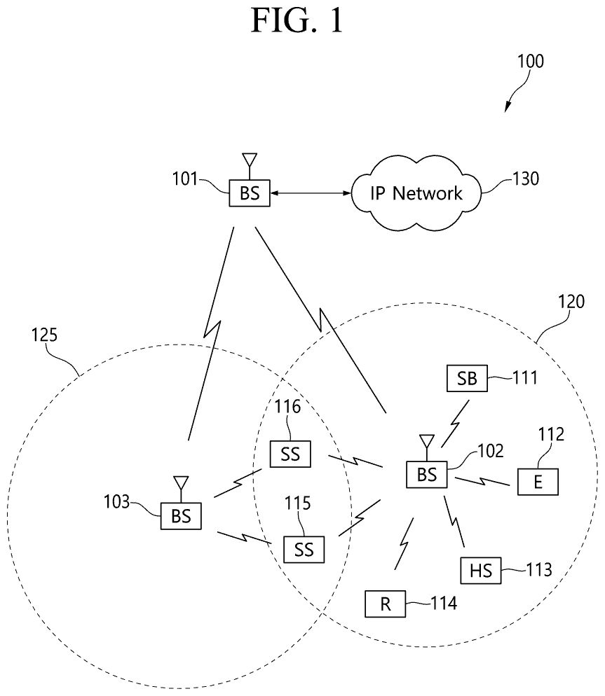

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

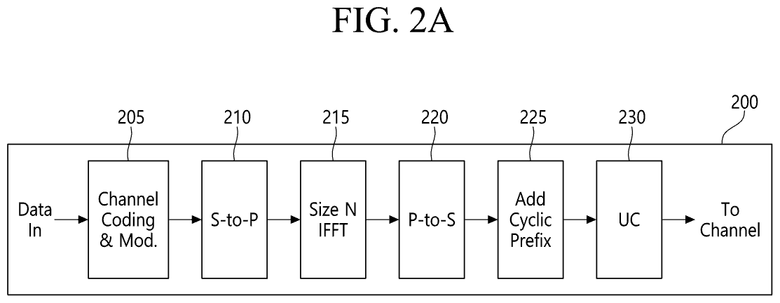

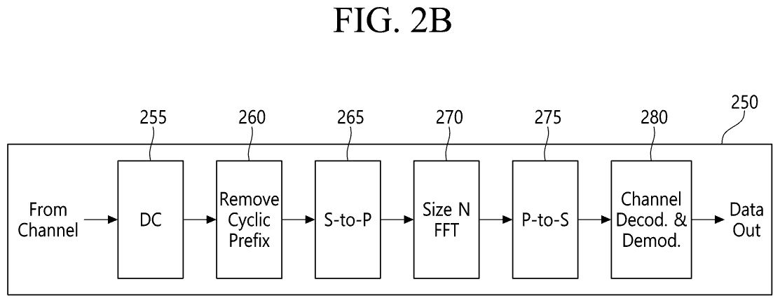

FIGS. 2A and 2B illustrate example wireless transmit and receive paths according to this disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

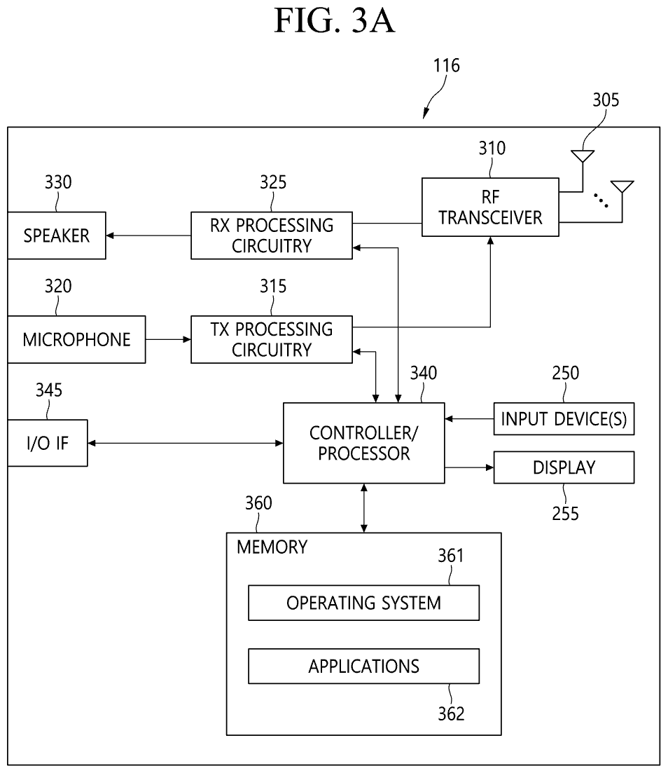

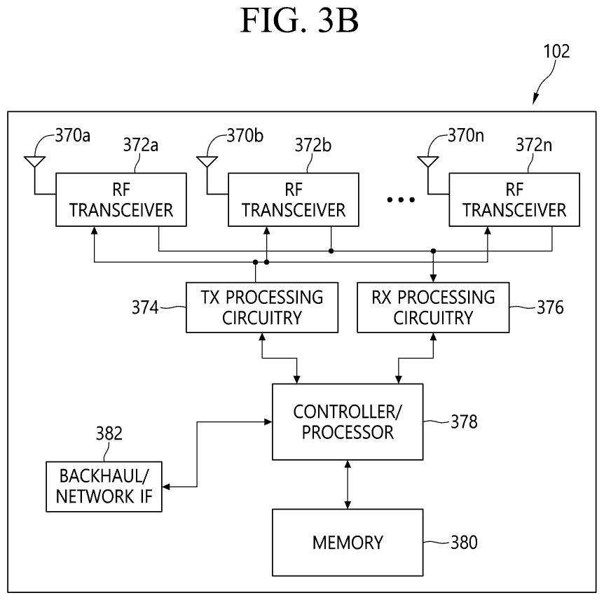

FIG. 3A illustrates an example UE 116 according to this disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to this disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of an gNB 102, various changes may be made to FIG. 3B. For example, the gNB 102 can include any number of each component shown in FIG. 3. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Rel. 13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel. 14 LTE. For next generation cellular systems such as 5G, it is expected that the maximum number of CSI-RS ports remain more or less the same.

For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies).

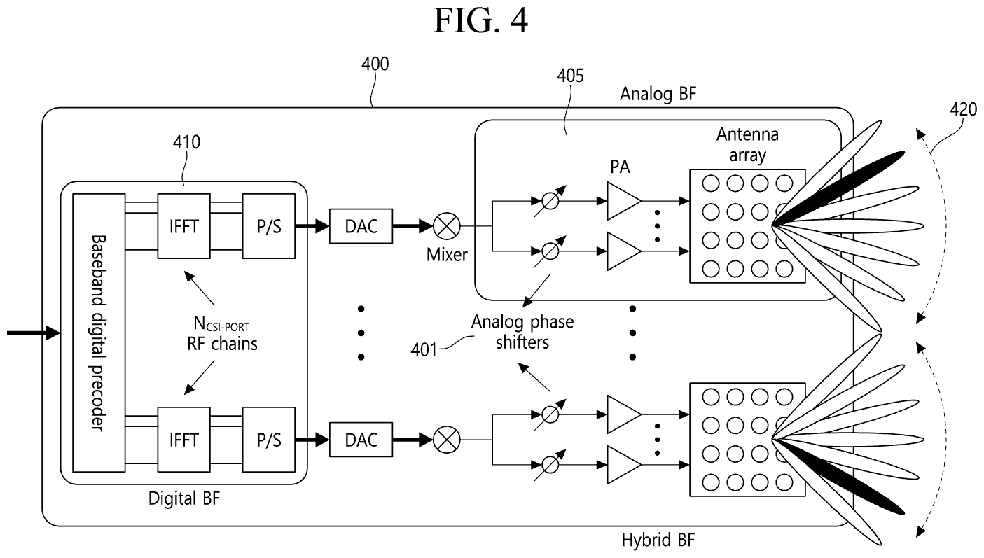

FIG. 4 illustrates a beamforming architecture in accordance an embodiment. In particular, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks.

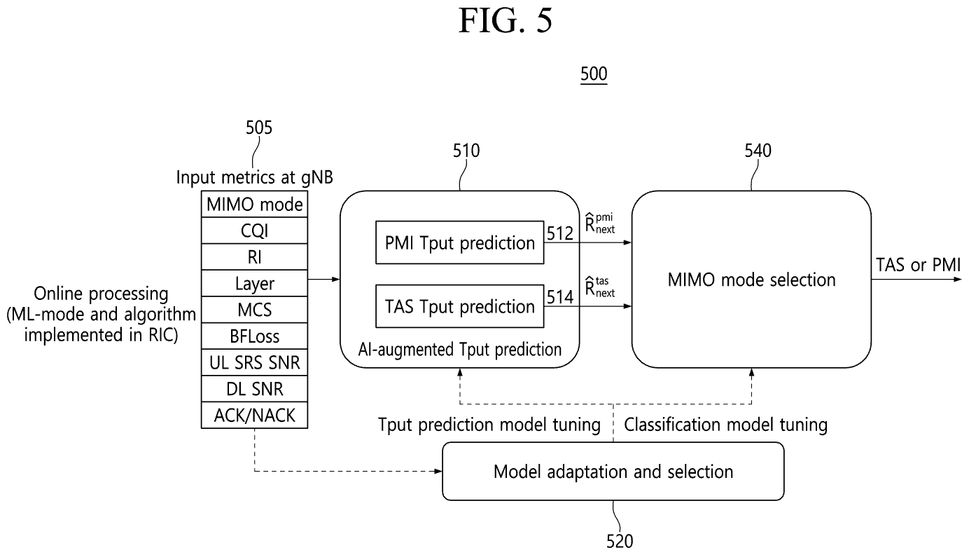

In modern wireless systems, such as those described regarding FIGS. 1-4, different modes of operation may be utilized for MIMO transmissions. For example, in some circumstances MIMO transmissions may utilize a precoding matrix indicator (PMI) mode. In other circumstances, a transmit antenna selection (TAS) mode may be utilized. Depending on the circumstances, for example the conditions near a BS, the position of a UE, etc. better throughput may be obtained by utilizing PMI mode, while in other circumstances better throughput may be obtained by utilizing TAS mode. For instance, it has been observed that in strong line of sight (LOS) conditions that performance may be degraded when utilizing TAS rather than PMI. To improve throughput performance, it may be beneficial to dynamically alternate between TAS and PMI modes as conditions change. To select the best mode between PMI and TAS, a throughput prediction based mode adaptation scheme may be utilized as illustrated in the example of FIG. 5.

FIG. 5 illustrates an example block diagram for an AI-augmented MIMO mode adaptation method 500 according to embodiments of the present disclosure. The embodiment of the AI-augmented MIMO mode adaptation method in FIG. 5 is for illustration only. Other embodiments of an AI-augmented MIMO mode adaptation method could be used without departing from the scope of this disclosure.

In the example of FIG. 5, a gNB (such as BS 103 of FIG. 1) receives a set of input metrics 505. Metrics 505 may include, but are not limited to metrics such as MIMO mode, channel quality indicator (CQI), rank indicator (RI), number of layers, modulation and coding scheme (MCS), beamforming loss (BFLoss), UL SRS signal-to-noise ratio (SNR), DL SNR, HARQ ACK/NACK, etc. These metrics may be available to the BS from SRS and PMI.

Metrics 505 may be utilized by the gNB to perform AI-augmented throughput prediction block 510 and model adaptation and selection 520. During prediction 510, the gNB generates a PMI throughput prediction block 512 and a TAS throughput prediction 514. Predictions 512 and 514 may be based on models selected and tuned by the gNB at block 520.

Based on the predictions generated in block 510, the gNB may perform a MIMO mode selection 540 and select between at least a TAS or a PMI mode. The selection may be based on a model selected and tuned by the gNB at block 520.

Although FIG. 5 illustrates one example of an AI-augmented MIMO mode adaptation method, various changes may be made to FIG. 5. For example, the input metrics may change, the models may change, etc.

Deriving a robust model for TAS throughput prediction is one of the most challenging tasks in the overall design of a MIMO mode adaptation scheme. The present disclosure describes a new processing framework of TAS throughput prediction for massive MIMO (mMIMO) as illustrated in the figures.

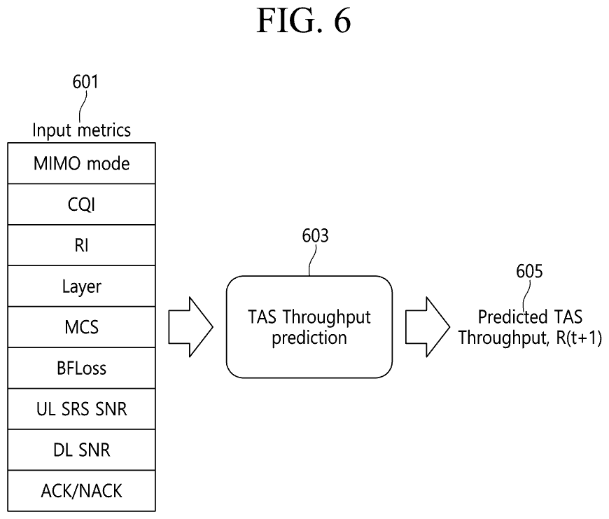

FIG. 6 illustrates a mMIMO processing framework in accordance with an embodiment. In FIG. 6, a mMIMO BS for TAS throughput prediction may include a transceiver configured to receive sounding reference signal (SRS) and precoding matrix indicator (PMI) from Physical Uplink Shared Channel (PUSCH) from a user equipment (UE). The SRS and PMI may provide one or more input metrics 601 which include a MIMO mode, channel quality indicator (CQI), rank indicator (RI), number of layers, modulation and coding scheme (MCS), beamforming loss (BFLoss), an uplink (UL) sounding reference signal (SRS) signal to noise ratio (SNR), a downlink (DL) SNR, or hybrid automatic repeat request (HARQ) acknowledgement (ACK)/negative acknowledgement (NACK). These metrics are available to the UE from the SRS and PMI.

The TAS throughput prediction unit 603 may use the one or more of the input metrics 601 for predicting TAS throughput 605. In some embodiments, the TAS throughput prediction unit 603 may use a linear model that maps signal to interference and noise ratio (SINR) in a dB domain to spectral efficiency (SE). In some embodiments, the SINR is estimated using uplink (UL) SINR, beamforming loss (BFloss), and a CQI value, where the mapping from CQI value to SINR can be universal, cell-specific, or user equipment specific. In some embodiments, the linear model may have one or more parameters, and different values of model parameters may be applied given channel conditions and system conditions. DL Channels associated with different SRS RX ports of the UE are sounded using SRS transmission with TIR4 ‘antenna switching’ UE transceiver as illustrated by FIG. 5 in accordance with an embodiment.

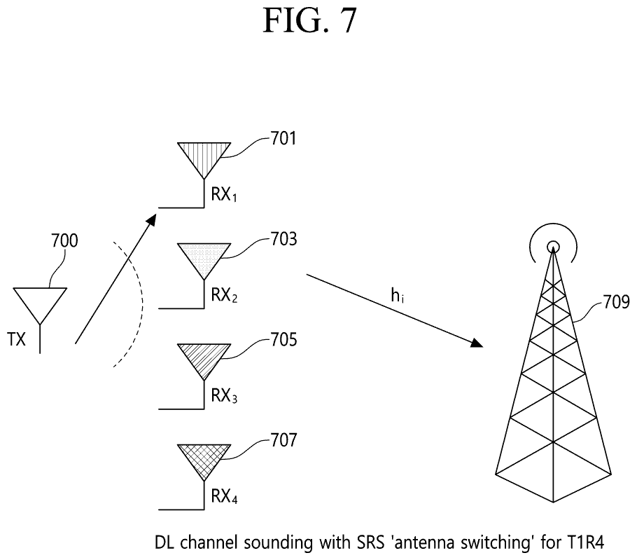

FIG. 7 illustrates an example of antenna switching in accordance with an embodiment. In particular, FIG. 7 illustrates DL channel sounding with SRS antenna switching for TIR4 in accordance with an embodiment. In particular, FIG. 7 illustrates TX port 700, RX ports 701, 703, 705, 707 and antenna element 709. In the example of FIG. 7, let the channel associated with i-th, i∈{0, 1, 2, 3} RX port 701, 703, 705, and 707 and n-th eNB antenna element 709 be, hᵢ(n), n∈{0, 1, . . . N−1}. Then, the estimated channel of i-th RX port, and (n)-th BS antenna element in the UL, \tilde{h}ᵢ(n) can be given by equation (1):

$${h}_{i} ( n ) = \sqrt{{P}_{tr}} {h}_{i} ( n ) + {n}_{i}^{UL} ( n ) , \qquad ( 1 )$$

where Pₜᵣ is the training TX power which takes into consideration all the losses at the TX side. In some embodiments, as channel sounding for all RX ports (701, 703, 705, and 707) are done using the same TX port 700 (e.g., SRS transmission with T1R4 ‘antenna switching’), the same training TX power may be assumed across all RX ports to be sounded.

$${n}_{i}^{U L}$$

is the complex Gaussian noise from

$$𝒞 𝒩 \{ 0 , {σ}_{U L}^{2} \} .$$

Given Equation (1), and assuming that the UL SRS SNR input to TAS throughput prediction unit is the average SNR over all BS antenna elements, UL SNR of i-th SRS port, SNRᵢ^{UL} can be given by equation (2):

$${SNR}_{i}^{UL} = \frac{1}{N} \frac{{P}_{tr} {‖ {h}_{i} ‖}^{2}}{{σ}_{UL}^{2}} . \qquad ( 2 )$$

where the channel of i-th RX port, hᵢ=[hᵢ(0) hᵢ(1) . . . hᵢ(N−1)]^{T}.

Next, the DL received signal at the i-th RX port can be given by equation (3):

$${y}_{i}^{D L} = \sqrt{{P}_{D L}} {h}_{i}^{H} {f}_{i} s + {n}_{i}^{D L} . \qquad ( 3 )$$

Here, the DL precoding vector is:

$${f}_{i} = \frac{1}{‖ {h}_{i} + {n}_{i} ‖} ( {h}_{i} + {n}_{i} ) \approx \frac{1}{\sqrt{( 1 + ρ )} ‖ {h}_{i} ‖} ( {h}_{i} + {n}_{i} ) where ρ = \frac{{‖ {n}_{i} ‖}^{2}}{{‖ {h}_{i} ‖}^{2}} .$$

P_{DL} is the DL Tx power and

$${n}_{i}^{D L}$$

is the complex Gaussian noise from

$$𝒞 𝒩 \{ 0 , {σ}_{D L}^{2} \} .$$

Subsequently, using Equation (2) and Equation (3), and considering the channel reciprocity, DL SNR observed at the i-th RX port can be approximately given by equation (4):

$$S N {R}_{i}^{D L} \approx \frac{{P}_{D L}}{{σ}_{D L}^{2}} \times \frac{1}{( 1 + ρ )} \times \frac{N {σ}_{U L}^{2} \times S N {R}_{i}^{U L}}{{P}_{tr}} \qquad ( 4 )$$

SNR captured in Equation (4) is for conjugate beamforming precoding. Assuming i-th RX port is mapped to l-th DL layer, for zero-force (ZF) beamforming, the SNR of l-th DL layer may be calculated by appropriately scaling

$$S N {R}_{l}^{D L}$$

### in Equation (4) as,

$$B {F}_{L O S {S}_{l}} \times S N {R}_{l}^{D L}$$

where BF_{LOSS}_{ₗ} , is the beamforming loss parameter of l-th layer. With that, instantaneous TAS throughput at l-th DL layer can be predicted approximately as given by equation (5):

$${R}_{l} ( t + 1 ) \approx {α}_{tas , 1} \times log \{ 1 + {\tilde{a}}_{tas , 2} \times B {F}_{L O S {S}_{l}} ( t ) \times S N {R}_{l}^{D L} ( t ) \} \qquad ( 5 )$$

where α_{tas,1} and \tilde{α}_{tas,2} are some parameters to be learned and/or determined. By applying Equation (4) in Equation (5), Rₗ(t+1) can be expressed using UL SNR as given by equation (6):

$${R}_{l} ( t + 1 ) \approx {α}_{tas , 1} \times log \{ 1 + {\tilde{a}}_{tas , 2} \times \frac{{P}_{D L}}{{σ}_{D L}^{2}} \times \frac{1}{( 1 + ρ )} \times \frac{N {σ}_{U L}^{2}}{{P}_{tr}} \times B {F}_{L O S {S}_{l}} ( t ) \times S N {R}_{l}^{U L} ( t ) \} . \qquad ( 6 )$$

In some embodiments, DL SNR in Equation (6),

$$\frac{{P}_{D L}}{{σ}_{D L}^{2}} ,$$

may be approximated by mapping the reported CQI value to an appropriate signal to interference and noise ratio (SINR) value, SINR_Map(CQI). Accordingly, Equation (6) can be updated as follows by equation (7):

$${R}_{l} ( t + 1 ) \approx {α}_{tas , 1} \times log \{ 1 + {\tilde{α}}_{tas , 2} \times \frac{1}{( 1 + ρ )} \times \frac{N {σ}_{U L}^{2}}{{P}_{tr}} \times S I N {R}_{Map ( CQI )} \times B {F}_{L O S {S}_{l}} ( t ) \times S N {R}_{l}^{U L} ( t ) \} . \qquad ( 7 )$$

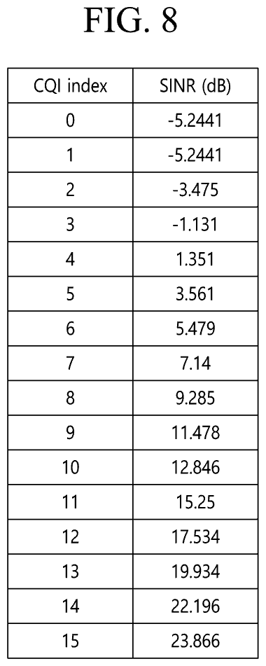

A table capturing different CQI values and corresponding SINR values may be defined. FIG. 8 illustrates a CQI-to-SINR mapping table in accordance with an embodiment.

Note that equation (7) is non-linear with two parameters, which may provide certain drawbacks, including 1) it may be difficult for an optimization algorithm to find optimal parameters during offline training, and/or 2) an algorithm may be needed to track or update the parameters during online operations.

To simplify the TAS Tput prediction model in Equation (7), embodiments in accordance with this disclosure may use simpler functions to approximate Equation (7) given the requirement of accuracy and limitation of complexity. In some embodiments, Equation (7) may be approximated by a piecewise linear function. For example, as provided by Equation (8):

$${R}_{l} ( t + 1 ) \approx {α}_{tas , 1} \times {f}_{snr \to se} ( SINR\_Map {( C Q I )}_{dB} + B {{F}_{L O S {S}_{l}} ( t )}_{dB} + S N {{R}_{l}^{U L} ( t )}_{dB} ) , \qquad ( 8 )$$

where f_{snr→se}(·) is a piecewise linear function approximating the logarithm function in the SINR range of interest, and SINR_Map(CQI)_{dB}, BF_{LOSS}_{ₗ}(t)_{dB} and

$$S N {{R}_{l}^{U L} ( t )}_{dB}$$

are the SINR mapping from CQI, BF loss and SRS SINR in dB domain. In some embodiments, a fixed f_{snr→se}(·) may be used.

In some embodiments, the system may store K functions denoted by

$${\{ {f}_{snr \to se}^{( k )} ( \cdot ) \}}_{k = 1}^{K}$$

and select one for TAS Tput prediction depending on the current status of the system. The current status of the system may include but not limited to the number of serving UEs, network load and power consumption, among others.

In some embodiments, the system may select different

$${f}_{snr \to se}^{( k )} ( \cdot ) ’ s$$

from

$${\{ {f}_{snr \to se}^{( k )} ( \cdot ) \}}_{k = 1}^{K}$$

for each UE with periodic SRS resource depending on the traffic type and QoS requirement.

In some embodiments, an approximation may include an arbitrary number of line segments with an arbitrary length starting at arbitrary SINR depending on the requirement of accuracy and the limitation of computational complexity. In some embodiments, f_{snr→se}(·) can be a piecewise linear function of, for example, five segments:

$${f}_{snr \to se} ( x ) = \{ \begin{matrix}0.0515 x + 0.6525 , & x < - 5 \\ 0.111 x + 0.95 , & - 5 \leq x < 0 \\ 0.2215 x + 0.95 , & 0 \leq x < 5 \\ 0.2804 x + 0.6554 & 5 \leq x < 10 \\ 0.3216 x + 0.2438 , & x \geq 10\end{matrix}$$

In some embodiments, the piecewise linear function may be further bounded by the lower and upper bound on the spectral efficiency per layer can be supported by the system, as follows:

$${f}_{snr \to se} ( x ) = min \{ max \{ \{ \begin{matrix}0.0515 x + 0.6525 , & x < - 5 \\ 0.111 x + 0.95 , & - 5 \leq x < 0 \\ 0.2215 x + 0.95 , & 0 \leq x < 5 \\ 0.2804 x + 0.6554 & 5 \leq x < 10 \\ 0.3216 x + 0.2438 , & x \geq 10\end{matrix} , 0 \} , max Se \} ,$$

Where maxSe is the maximum spectral efficiency of the system.

In certain embodiments, the piecewise linear function may be further bounded by the lower and upper bound on the total spectral efficiency can be supported by the system, as follows:

$${\sum }_{l = 1}^{L} {f}_{snr \to se} ( {x}_{l} ) = min \{ {\sum }_{i = 1}^{L} max \{ \{ \begin{matrix}0.0515 {x}_{l} + 0.6525 , & x < - 5 \\ 0.111 {x}_{l} + 0.95 , & - 5 \leq x < 0 \\ 0.2215 {x}_{l} + 0.95 , & 0 \leq x < 5 \\ 0.2804 {x}_{l} + 0.6554 & 5 \leq x < 10 \\ 0.3216 {x}_{l} + 0.2438 , & x \geq 10\end{matrix} , 0 \} , max Se \times L \} ,$$

where L is the maximum layer for DL transmission of a UE.

Define

$${EffSINR}_{l} = SINR\_Map {( CQI )}_{dB} + {{BF}_{LOS {S}_{l}} ( t )}_{dB} + S N {{R}_{l}^{UL} ( t )}_{dB}$$

which can be viewed as the scaled effective DL SINR of the l-th layer. SINR_MAP(CQI)_{dB} is the mapping from CQI value to estimate SINR. In some embodiments, a single SINR_MAP(CQI)_{dB} is applied for all the cells in the network regardless of the configurations. In certain embodiments, SINR_MAP(CQI)_{dB} is applied for all the cells in the network depending on configurations. In some embodiments, SINR_MAP(CQI)_{dB} is cell or site-specific. For example, each cell or site may have different SINR_MAP(CQI)_{dB}. In some embodiments, SINR_MAP(CQI)_{dB} is UE-specific. For example, each UE is applied with different SINR_MAP(CQI)_{dB}.

In some embodiments, the TAS Tput can be predicted by a linear function of EffSINRₗ. In some embodiments, TAS Tput can be predicted by the scaled spectral efficiency mapping from the summation of EffSINRₗ and the offset determined by parameter α_{tas,2}:

$${R}_{l} ( t + 1 ) \approx {α}_{tas , 1} \times {f}_{snr \to se} ( {EffSINR}_{l} + {α}_{tas , 2} )$$

In some embodiments, Equation (7) can be approximated by the scaled spectral efficiency obtained by f_{snr→se}(·) with offset determined by α_{tas,2}:

$${R}_{l} ( t + 1 ) \approx {α}_{tas , 1} \times {f}_{snr \to se} ( {EffSINR}_{l} ) + {α}_{tas , 2} .$$

In some embodiments, Equation (7) can be approximated by the summation of spectral efficiency derived from SINR:

$${R}_{l} ( t + 1 ) \approx {α}_{tas , 1} {f}_{snr \to se} ( {SINR}_{{Map ( CQI )}_{dB}} ) + {α}_{tas , 2} {f}_{snr \to se} ( {{BF}_{LOS {S}_{l}} ( t )}_{dB} + {{SNR}_{l}^{UL} ( t )}_{dB} )$$

In some embodiments, Equation (7) can be approximated by:

$${R}_{l} ( t + 1 ) \approx {α}_{tas , 1} \times {f}_{cqi \to se} ( CQI ) + {α}_{tas , 2} \times {f}_{snr \to se} ( {{BF}_{LOS {S}_{l}} ( t )}_{dB} + {{SNR}_{l}^{UL} ( t )}_{dB} )$$

In some embodiments,

$${\{ {α}_{tas , 1}^{k} \}}_{k = 1}^{K}$$

with K being the number of different throughput prediction models available, may be learnt for different cells or different sites (hence cell/site specific models). In some embodiments, these models can be common to all cells/sites and hence learnt jointly.

In some embodiments, models can be learnt UE specifically. In some embodiments, there can be multiple pre-defined value sets defined for those two model parameters and based on some criteria, one value set out of those pre-defined value sets may be identified.

In some embodiments, a single α_{tas,1} can be used regardless of channel conditions. In some embodiments, a single α_{tas,1} is used if the network load is large or the power consumption is limited. In some embodiments, α_{tas,1} is used if the hardware capability does not meet certain requirement.

In some embodiments, the parameter α_{tas,1} can also be selected by channel conditions. In some embodiments, following two throughput prediction models based on UL SNR can be defined:

$$\{ {α}_{tas , 1} ( UL\_SNR ) \} = \{ \begin{matrix}{α}_{tas , 1}^{1} , {UL}_{SNR ( t )} < {γ}_{snr} \\ {α}_{tas , 1}^{2} , UL\_SNR ( t ) \geq {γ}_{snr}\end{matrix}$$

In some embodiments, the throughput prediction model is determined by:

$$\{ {α}_{tas , 1} ( UL\_SNR ) \} = \{ \begin{matrix}{α}_{tas , 1}^{1} , {UL}_{SNR ( t )} < {γ}_{speed} \\ {α}_{tas , 1}^{2} , UL\_SNR ( t ) \geq {γ}_{speed}\end{matrix}$$

In some embodiments, the throughput prediction model is determined by multiple conditions of channels.

In some embodiments,

$${\{ {α}_{tas , 1}^{k} \}}_{k = 1}^{K}$$

with K being the number of different throughput prediction models available, may be learnt for different cells or different sites (hence cell/site specific models). In some embodiments, these models can be common to all cells/sites and hence learnt jointly.

In some embodiments, the models can be learnt UE specifically as well. In addition, there can be multiple pre-defined value sets defined for those two model parameters and based on some criteria, one value set out of those pre-defined value sets may be identified.

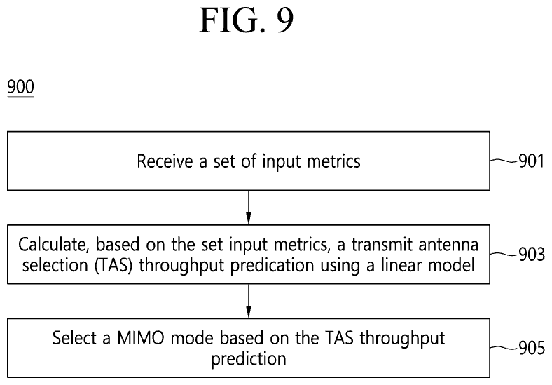

FIG. 9 illustrates a flow chart of an example process of computing TAS throughput using a linear model in accordance with an embodiment. Although one or more operations are described or shown in particular sequential order, in other embodiments the operations may be rearranged in a different order, which may include performance of multiple operations in at least partially overlapping time periods.

The process 900, in operation 901, the station receives a set of input metrics. In some embodiments, the set of input metrics may include a channel quality indicator (CQI), a rank indicator (RI), a number of layers, a modulation an coding scheme (MCS), a beamforming loss (BFloss), an uplink (UL) sounding reference signal (SRS) signal to noise ratio (SNR), a downlink (DL) SNR, or hybrid automatic repeat request (HARQ) acknowledgement (ACK)/negative acknowledgement (NACK).

In operation 903, the station calculates, based on the set of input metrics, a transmit antenna selection (TAS) throughput prediction using a linear model. In some embodiments, the linear model maps signal to interference and noise ratio (SINR) in a dB domain to spectral efficiency (SE). In some embodiments, the SINR is estimated using uplink (UL) SINR, beamforming loss (BFloss), and a CQI value, where the mapping from CQI value to SINR can be universal, cell-specific, or user equipment specific. In some embodiments, the linear model may have one or more parameters, and different values of model parameters may be applied given channel conditions and system conditions.

In operation 905, the station selects a MIMO mode based on the TAS throughput prediction. In some embodiments, the station may select between TAS mode and a precoding matrix indicator (PMI) mode.

Embodiments in accordance with this disclosure provide for calculating throughput prediction for MIMO mode selection using a linear model, which can reduce complexity of throughput computation and model adaption and selection while maintaining performance. In particular, embodiments may use a piece-wise linear mapping from effective DL SINR in dB domain to spectral efficiency (SE) to ensure that the model is linear, whereby the mapping may be selected to satisfy requirements regarding accuracy and computational resource usage.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A base station (BS) in a wireless network, comprising:
a memory; and
a processor coupled to the memory, the processor configured to:
receive, from a user equipment (UE), a set of input metrics;
perform, from the set of input metrics, a mapping from a channel quality indicator (CQI) to signal to noise ratio (SNR);
perform a transmit antenna selection (TAS) throughput prediction using a linear model that uses the mapping from the CQI to SNR; and
select a TAS mode as a multiple input multiple output (MIMO) mode based on the TAS throughput prediction.

2. The BS of claim 1, wherein the set of input metrics is associated with at least one of a CQI, a rank indicator, a number of layers, a modulation and coding scheme, a beamforming loss, an uplink sounding reference signal (SRS) signal to noise ratio (SNR), a downlink SNR, or a hybrid automatic repeat request (HARQ) acknowledgement and negative acknowledgement.

3. The BS of claim 1, wherein the TAS throughput predication is approximated by a linear function based on the mapping from CQI to SNR, a beamforming loss, and an SRS to generate a spectral efficiency.

4. The BS of claim 3, wherein the linear function is bounded by a lower bound and an upper bound on the spectral efficiency per layer that is supported by the BS.

5. The BS of claim 3, wherein the linear function is bounded by a lower bound and an upper bound on a total spectral efficiency that is supported by the BS.

6. The BS of claim 1, wherein the processor is further configured to select a particular linear function from a plurality of linear functions based on at least one of a number of UEs, a network load, or a power consumption.

7. The BS of claim 1, wherein the processor is further configured to select a particular linear function from a plurality of linear functions for a particular UE based on a traffic type or a quality of service (QoS) requirement.

8. The BS of claim 1, wherein the mapping from CQI to SNR is variable based on a cell to which the BS belongs, a UE with which the BS communicates, or a configuration of the BS.

9. The BS of claim 1, wherein the processor is further configured to offset the TAS throughput predication by a pre-defined parameter.

10. The BS of claim 1, wherein the TAS throughput predication is performed based on a parameter that changes based on uplink SNR or based on UE speed.

11. A computer-implemented method for communication by a base station (BS) in a wireless network, comprising:
receiving, from a user equipment (UE), a set of input metrics;
performing, from the set of input metrics, a mapping from a channel quality indicator (CQI) to signal to noise ratio (SNR);
performing a transmit antenna selection (TAS) throughput prediction using a linear model that uses the mapping from the CQI to SNR; and
selecting a TAS mode as a multiple input multiple output (MIMO) mode based on the TAS throughput prediction.

12. The computer-implemented method of claim 11, wherein the set of input metrics is associated with at least one of a CQI, a rank indicator, a number of layers, a modulation and coding scheme, a beamforming loss, an uplink sounding reference signal (SRS) signal to noise ratio (SNR), a downlink SNR, or a hybrid automatic repeat request (HARQ) acknowledgement and negative acknowledgement.

13. The computer-implemented method of claim 11, wherein the TAS throughput predication is approximated by a linear function based on the mapping from CQI to SNR, a beamforming loss, and an SRS to generate a spectral efficiency.

14. The computer-implemented method of claim 13, wherein the linear function is bounded by a lower bound and an upper bound on the spectral efficiency per layer that is supported by the BS.

15. The computer-implemented method of claim 13, wherein the linear function is bounded by a lower bound and an upper bound on a total spectral efficiency that is supported by the BS.

16. The computer-implemented method of claim 11, further comprising selecting a particular linear function from a plurality of linear functions based on at least one of a number of UEs, a network load, or a power consumption.

17. The computer-implemented method of claim 11, further comprising selecting a particular linear function from a plurality of linear functions for a particular UE based on a traffic type or a quality of service (QoS) requirement.

18. The computer-implemented method of claim 11, wherein the mapping from CQI to SNR is variable based on a cell to which the BS belongs, a UE with which the BS communicates, or a configuration of the BS.

19. The computer-implemented method of claim 11, further comprising offsetting the TAS throughput predication by a pre-defined parameter.

20. The computer-implemented method of claim 11, wherein the TAS throughput predication is performed based on a parameter that changes based on uplink SNR or based on UE speed.
